(19) United States
(12) Patent Application Publication
(10) Pub. No.: US 2009/0197099 A1
(43) Pub. Date: Aug. 6, 2009

(54) THERMAL INTERFACE MATERIAL AND METHOD FOR MAKING THE SAME

(76) Inventor: Jun-Wei SU, Chiayi City (TW)

Correspondence Address: Brinks Hofer Gilson & Lione/Ann Arbor, 524 South Main Street, Suite 200, Ann Arbor, MI, 48104, US

(21) Appl. No.: 12/175,075

(22) Filed: Jul. 17, 2008

(30) Foreign Application Priority Data
Feb. 1, 2008 (TW) 097103963

(51) Int. Cl. C09K 5/14; B32B 25/20

(52) U.S. Cl. 428/447; 252/67

(57) ABSTRACT

A thermal interface material includes: a viscous material of silicone polymer; and a modified carbon nanotube material dispersed in the viscous material and having a formula: Y—(COX)ₙ; wherein n>1; wherein Y is carbon nanotube, and X is selected from one of OR₁ and NR₂R₃; and wherein R₁ is C₁-C₂₇ alkyl group, R₂ is C₁-C₁₈ alkyl group, and R₃ is C₁-C₁₈ alkyl group.

### CROSS-REFERENCE TO RELATED APPLICATION

This application claims priority of Taiwanese application no. 097103963, filed on Feb. 1, 2008.

### BACKGROUND OF THE INVENTION

1. Field of the Invention

This invention relates to a thermal interface material, more particularly to a thermal interface material having a modified carbon nanotube therein.

2. Description of the Related Art

A conventional electronic device usually has a thermal interface material for mounting of the electronic device on a heat dissipating substrate so as to prevent heat from accumulating in the electronic device and so as to improve performance and service life thereof.

Taiwanese Patent Application Nos. 200725840, 200724659, 200708610 and 00571332 disclose a thermal interface material including a matrix material of polysilane and a plurality of inorganic particulates, such as graphite, BN compound, silicone, silver, and other conductive metals, dispersed in the matrix material. The particulates in the matrix material can dissipate heat, but have disadvantages in that if numbers of the particulates are not enough to form a continuous path for heat dissipation, heat dissipation from the electronic device to the heat dissipating substrate wilI be relatively poor, thereby resulting in a decrease in heat dissipating efficiency. In addition, a thickness of the applied thermal interface material on the heat dissipating substrate can not be effectively reduced due to the size of particulates which are normally in the order of micrometers. Moreover, the particulates may undesirably scrape a surface of the electronic device due to a high rigidity of the particulates, and have a poor dispersion in the matrix material.

Taiwanese Patent Application Nos. 200640781 and 200411038 disclose carbon nano heat sink including a matrix material and carbon nano fibers or carbon nano capsules for replacing the above described inorganic particulates, thereby permitting a reduction in the thickness of the applied thermal interface material on the heat dissipating substrate. However, adsorption between the carbon nano fibers or carbon nano capsules and the matrix material is still insufficient, thereby resulting in segregation of the matrix material (i.e., it is likely to overflow when heated by the electronic component) and in non-uniform dispersion of the carbon nano fibers or carbon nano capsules in the matrix material.

U.S. Pat. Nos. 7,186,020 and 7,301,232 disclose a thermal interface material including a matrix material and a carbon nanotube material of single-wall carbon nanotubes. Although single-wall carbon nanotubes have excellent heat conductivity, problems, such as the aforesaid adsorption and non-uniform dispersion, still exist in practical use, thereby resulting in poor heat dissipating efficiency.

U.S. Pat. Nos. 7,296,576, 7,285,591, 7,279,247, 7,244,407, 7,241,496, 7,211,364, 6,905,667, and 6,887,450 disclose carbon nanotubes modified with different functional groups for improving the adsorption between the matrix material and the carbon nanotubes. However, the adsorption between the modified carbon nanotubes and the matrix material is still relatively poor. Hence, there is a need to find a modified carbon nanotube material that can enhance the adsorption with the matrix material, that can enhance the adhesion of the applied thermal interface material on the heat dissipating substrate, and that can permit an increase in the blending amount of the same in the matrix material so as to increase the contact among the carbon nanotubes for forming a continuous heat conduction phase.

### SUMMARY OF THE INVENTION

Therefore, an object of the present invention is to provide a thermal interface material that can overcome the above drawbacks associated with the prior art.

Another object of this invention is to provide a method for making the thermal interface material.

According to one aspect of the present invention, there is provided a thermal interface material that comprises: a viscous material of silicone polymer; and a modified carbon nanotube material dispersed in the viscous material and having a formula: Y—(COX)ₙ; wherein n>1; wherein Y is carbon nanotube, and X is selected from one of OR₁ and NR₂R₃; and wherein R₁ is C₁-C₂₇ alkyl group, R₂ is C₁-C₁₈ alkyl group, and R₃ is C₁-C₁₈ alkyl group.

According to another aspect or this invention, a method for making the thermal interface material comprises: (a) preparing a modified carbon nanotube material having a formula: Y—(COX)ₙ, wherein n>1, wherein Y is carbon nanotube, and X is selected from one of OR₁ and NR₂R₃, and wherein R₁ is C₁-C₂₇ alkyl group, R₂ is C₁-C₁₈ alkyl group, and R₃ is C₁-C₁₈ alkyl group; (b) mixing the modified carbon nanotube material with a viscous material of silicone polymer; and (c) homogenizing the mixture of step (b).

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view of an electronic device attached to a heat dissipating substrate through the preferred embodiment of a thermal interface material according to this invention; and

FIG. 2 is a plot showing temperature/time relation during a heat dissipating test for Example 10 and Comparative Examples 8-10.

### DETAILED DESCRIPTION OF THE PREFERRED EMBODIMENT

The preferred embodiment of a thermal interface material according to this invention includes: a viscous material of an organic silicone polymer; and a modified carbon nanotube material dispersed in the viscous material and having a formula: Y—(COX)ₙ; wherein n>1; wherein Y is carbon nanotube, and X is selected from one of OR₁ and NR₂R₃; and wherein R₁ is C₁-C₂₇ alkyl group, R₂ is C₁-C₁₈ alkyl group, and R₃ is C₁-C₁₈ alkyl group.

Preferably, n ranges from 3 to 18,more preferably, ranges from 6 to 12.

Preferably, the viscous material is in an amount ranging from 5 to 100 parts by weight per 1 part by weight of the modified carbon nanotube material, more preferably, in an amount ranging from 5 to 10 parts by weight per 1 part by weight of the modified carbon nanotube material.

Preferably, the silicone polymer is selected from the group consisting of silicone oil, modified silicone oil, and combinations thereof.

Preferably, the silicone oil is selected from the group consisting of methyl phenyl silicone oil, methyl silicone oil, and combinations thereof.

Preferably, the modified silicone oil is selected from one of reactive silicone oil and non-reactive silicone oil.

Preferably, the reactive silicone oil is selected from the group consisting or carboxyl-modified silicone oil, methyl alcohol-modified silicone oil, isobutyl-modified silicone oil, heterofunctional group-modified silicone oil, phenol-modified silicone oil, epoxy-modified silicone oil, amine-modified silicone oil, and combinations thereof.

Preferably, the non-reactive silicone oil is selected from the group consisting of fluorine-modified silicone oil, higher alkoxyl-modified silicone oil, higher fatty acid polyester-modified silicone oil, alkyl-modified silicone oil, methyl styrene-modified silicone oil, polyester-modified silicone oil, and combinations thereof.

Preferably, the carbon nanotube (Y) of the carbon nanotube material has a diameter ranging from 2nm to 250 nm, and a length ranging from 200 nm to 150 μm, and the ratio of the length to the diameter is greater than or equal to 100.

Preferably, the carbon nanotube (Y) of the carbon nanotube material is selected from the group consisting of single-wall carbon nanotube, double-wall carbon nanotube, multi-wall carbon nanotube, thin-wall carbon nanotube, thick-wall carbon nanotube, and combinations thereof.

Preferably, the thermal interface material further includes an inorganic filler material.

Preferably, the inorganic filler material includes conductive nanoparticles In an amount ranging from 10 to 20 parts by weight per 1 part by weight of the modified carbon nanotube material.

Preferably, the conductive nanoparticles are made from a material selected from the group consisting of Au, Ag, Al, Sn, Cu, Ga, Ga—In alloy, AlN, Al₂O₃, SiC, Si, BN, ZnO, SiO₂, quartz, diamond, and combinations thereof.

In this embodiment, the mixture of the silicone polymer and the carbon nanotube material is formed into an emulsion.

This invention also provides a method for forming the thermal interface material including: (a) heating the carbon nanotube material under a temperature ranging from 150° C. to 475° C.; (b) purifying the carbon nanotube material; (c) subjecting the carbon nanotube material to carboxylation so as to form carboxylated carbon nanotube material; (d) subjecting the carboxylated carbon nanotube material to chlorination so as to form acyl chloride carbon nanotube material; (e) subjecting the acyl chloride carbon nanotube material to nucleophilic substitution by a function group selected from one of the OR₁ and the NR₂R₃ so as to form the modified carbon nanotube material; (f) mixing the modified carbon nanotube material with the viscous material of silicone polymer; and (g) homogenizing the mixture of step (f).

Preferably, the homogenization of the mixture in step (g) is conducted through at least one of mechanical stirring and ultrasonic vibration techniques.

In this embodiment, the method further includes emulsifying the mixture of step (g), which is conducted by mechanical stirring under a stirring speed ranging from 2500 rpm to 6000 rpm and a temperature ranging from 25° C. to 100° C.

Preferably, the heating in step (a) can be conducted in nitrogen, air, or a vacuum ambient under a temperature ranging from 375° C. to 475° C. from 300° C. to 400° C., and from 150° C. to 210° C., respectively for obtaining a surface graphitization of the carbon nanotube (Y) of the carbon nanotube material.

Preferably, the purifying in step (b) is conducted in a solution of 6-12M hydrogen chloride under a temperature ranging from 50° C. to 120° C. for 4-24 hours, and followed by rinsing in deionized water until the solution has a pH value of about 4. Finally, the carbon nanotube (Y) of the carbon nanotube material is heated in an oven under a temperature ranging from 90° C. to 350° C. Preferably, the carbon nanotube (Y) of the carbon nanotube material is heated at temperatures of 90° C., 95° C., 100° C., 110° C., 120° C., and 250° C. for 3-12 hours, respectively.

Preferably, the carboxylation in step (c) is conducted in a solution of nitric acid under a temperature ranging from 50° C. to 120° C. for 24-72 hour.

Preferably, the chlorination in step (d) is conducted in a solution of thionyl chloride (SOCl₂) for 30 min to 24 hours.

In this embodiment, the nucleophilic substitution by reacting with alcohol produces the modified carbon nanotube material having a formula: Y—(COOR₁)ₙ, wherein the alcohol is selected from one of C₁-C₂₇ primary alcohol, C₁-C₂₇ secondary alcohol, C₁-C₂₇ tertiary alcohol, and C₁-C₂₇ polyols.

Alternatively, the nucleophilic substitution by reacting with amine produces the modified carbon nanotube material having a formula: Y—(CONR₂R₃)ₙ, wherein the amine is RNR₂R₃ and R is H or C₁-C₁₈ acryl group.

Preferably, the viscous material of silicone polymer is heated under a temperature of 40° C. to 200° C. prior to step (f)

Preferably, the homogenizing in step (g) is conducted through mechanical stirring under a stirring speed ranging from 1200 rpm to 10000 rpm, a temperature ranging from 40° C. to 150° C., and a pressure ranging from 0.1 to 50 torr.

Preferably, the homogenizing in step (g) is conducted through ultrasonic vibration under a power ranging from 250 W to 1500 W for 30 to 20 min.

Preferably, the method further includes degassing the mixture by mechanical stirring under a speed ranging from 1000 rpm to 3600 rpm after step (g).

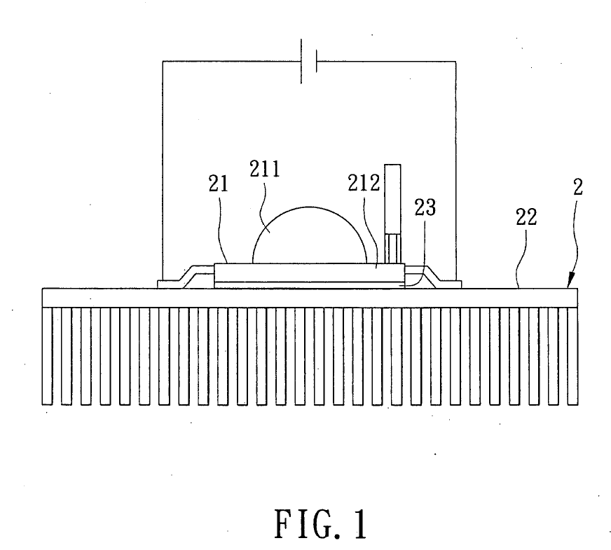

This invention also provides an electronic device 2 that includes: a heat dissipating substrate 22; an electronic component 21 disposed on the substrate 22; and the thermal interface material 23 disposed between and in contact with the heat dissipating substrate 22 and the electronic component 21 (see FIG. 1).

The electronic component 21 has a heat source 211, which generates heat after applying electricity thereto, and a heat-dissipating seat 212 disposed between the heat source 211 and the heat dissipating substrate 22.

In this embodiment, the electronic component 21 is a light-emitting device, such as a light emitting diode.

The merits of the thermal interface material of this invention will become apparent with reference to the following Examples and Comparative Examples.

### EXAMPLE

### Examples 1-5 (E1-E5)

A carbon nanotube material of multi-walled nanotubes was immersed in a solution of 10 M nitric acid under a temperature of 80° C. for 4 hour. After removing the nitric acid, thionyl chloride was added into the acid-derivatized carbon nanotube material which was cooled using an iced bath, followed by raising a temperature up to 60° C. and maintaining the temperature for 6 hour, which converted carboxyl acid to acid chloride. Subsequently, the acid chloride carbon nanotube material thus formed was added into a solvent of melted hexyl alcohol (Note: when the employed alcohol has a relatively high boiling point, an alcohol-dissoluble solvent, such as dichloromethane, can be used to dissolve the high boiling point alcohol.) to undergo esterification. The modified carbon nanotube material thus formed was mixed with dimethyl silicone oil, that was heated to a temperature of 120° C. in advance, under a temperature of 120° C. for 2 hour. The mixture was homogenized by mechanical stirring under a rotation speed of 1200 rpm and a temperature of 80° C. for 1 hour in a homogenization machine (Shin-kwang, G300-R) was subjected to high frequency vibration in an ultrasonic vibration machine (Sonics & Materials, Inc. USA, VCF 1500 HV) under a power of 750 W for 600 sec to enhance dispersion of the modified carbon nanotube material in the dimethyl silicone oil, followed by emulsifying the mixture of the modified carbon nanotube material and the dimethyl silicone oil by mechanical stirring under a rotation speed of 2500 rpm and a temperature of 60° C. for 30 min in an emulsilier (ROSS HSM-101) for adjustment of the viscosity of the mixture. The mixture was further mechanically stirred under a rotation speed of 450 rpm and a temperature of 60° C. for 2 hr in a mixer (EXAKT 80s) for further adjustment of the viscosity of the mixture.

For removal of bubbles in the mixture and further adjustment to the viscosity of the mixture, the mixture was stirred and degassed for 5 min in a rotation/revolution mixer (THINKY ARE-500), wherein the stirring was conducted under a rotation speed of 720 rpm and a revolution of 1800 rpm, and the degassing was conducted under a rotation speed of 49 rpm and a revolution of 1800 rpm.

### Examples 6-11 (E6-E11)

The process conditions of Examples 6-11 were similar to those of Examples 1-5, except that the thermal interface material of each of Examples 6-11 further includes an inorganic filler material of Al powder.

Table 1 shows the content of each of the components of the thermal interface material of Examples 1-11.

TABLE 1

| | Modified | | |
|---|---|---|---|
| | carbon | | |
| | nanotube | | |
| | material | | |
| | (hexyl | | Inorganic |
| | alcohol | Silicone | filled |
| | modified) | oil | material |
| | (wt %) | (wt %) | (wt %) |
| E1 | 1 | 100 | — |
| E2 | 1 | 50 | — |
| E3 | 1 | 20 | — |
| E4 | 1 | 10 | — |
| E5 | 1 | 5 | — |
| E6 | 1 | 100 | 10 |
| E7 | 1 | 100 | 20 |
| E8 | 1 | 50 | 20 |
| E9 | 1 | 20 | 20 |
| E10 | 1 | 10 | 10 |
| E11 | 1 | 5 | 10 |

where “—” means not added

### Example 12

The process conditions of Example 12 were similar to those of Example 4, except that the modified carbon nanotube material did not undergo the emulsion process and was subjected to ultrasonic vibration only.

### Comparative Example 1 (CE1)

The process conditions of Comparative Example 1 were similar to those of Example 4, except that the modified carbon nanotube material was formed by reacting the carbon nanotube material with sodium p-stryenesulfonate.

### Comparative Example 2 (CE2)

The process conditions of Comparative Example 2 were similar to those of Example 4, except that the modified carbon nanotube material was formed by reacting the carbon nanotube material with styrene.

### Comparative Example 3 (CE3)

The process conditions of Comparative Example 3 were similar to those of Example 4, except that the modified carbon nanotube material was formed by reacting the carbon nanotube material with ethylene.

### Comparative Example 4 (CE4)

The process conditions of Comparative Example 4 were similar to those of Example 4, except that the modified carbon nanotube material was formed by reacting the carbon nanotube material with methyl ethylene.

### Comparative Example 5 (CE5)

The process conditions of Comparative Example 5 were similar to those of Example 4, except that the modified carbon nanotube material was formed by reacting the carbon nanotube material with epoxy resin.

### Comparative Example 6 (CE6)

The process conditions of Comparative Example 6 were similar to those of Example 4, except that the carbon nanotube material was not modified and did not undergo the ultrasonic vibration.

### Comparative Example 7 (CE7)

The process conditions of Comparative Example 7 were similar to those of Example 4, except that the modified carbon nanotube material was formed by reacting the carbon nanotube material with the nitric acid only.

The coefficients of thermal conductivity of Examples 1-12 and Comparative Examples 1-7 were measured based on ASTM D5470-2006. The results are shown in Table 2.

TABLE 2

| | Coefficient of |
|---|---|
| | thermal |
| | conductivity |
| | (W/m · K) |
| E1 | 0.8 |
| E2 | 2.4 |
| E3 | 4.2 |
| E4 | 10.7 |
| E5 | 24.5 |
| E6 | 1.2 |
| E7 | 2.1 |
| E8 | 3.5 |
| E9 | 5.6 |
| E10 | 11.5 |
| E11 | 29.5 |
| E12 | 7.9 |
| CE1 | 2.9 |
| CE2 | 2.6 |
| CE3 | 3.2 |
| CE4 | 2.9 |
| CE5 | 2.0 |
| CE6 | 1.5 |
| CE7 | 2.8 |

The results show that the higher the ratio of the modified carbon nanotube material to the silicone oil, the higher will be the coefficient of thermal conductivity. Moreover, addition of inorganic filler material in Examples 6-11 improves the coefficient of thermal conductivity as compared to those of Examples 1-5.

Compared to the modified carbon nanotube material of Comparative Examples 1-5, which were conducted through radical addition polymerization, and Comparative Examples 6 and 7, the modified carbon nanotube material of Example 4 has a much higher coefficient of thermal conductivity.

### Heat Dissipation Test

Test on Example 10 (E10)

A heat dissipating substrate made from a stainless steel was provided, onto which a light-emitting device (LED) was attached by applying the thermal interface material of Example 10 therebetween. A 900 mA current and 4.0 voltage were applied on the LED, and the temperature of the LED was measured continuously for a period of time.

Test on Comparative Example 8 (CE8)

The test was prepared by steps similar to those for Example 10, except that the LED was directly attached to the substrate without the thermal interface material.

Test on Comparative Example 9 (CE9)

The test was prepared by steps similar to those of Example 10, except that the thermal interface material was replaced by a commercial heat-dissipating pad (Dow Corning, OTR-ICE-PAD).

Test on Comparative Example 10 (CE10)

The test was prepared by steps similar to those of Example 10, except that the thermal interface material was replaced by a commercial heat sink (JetArt Technology Co., Ltd., CK4800).

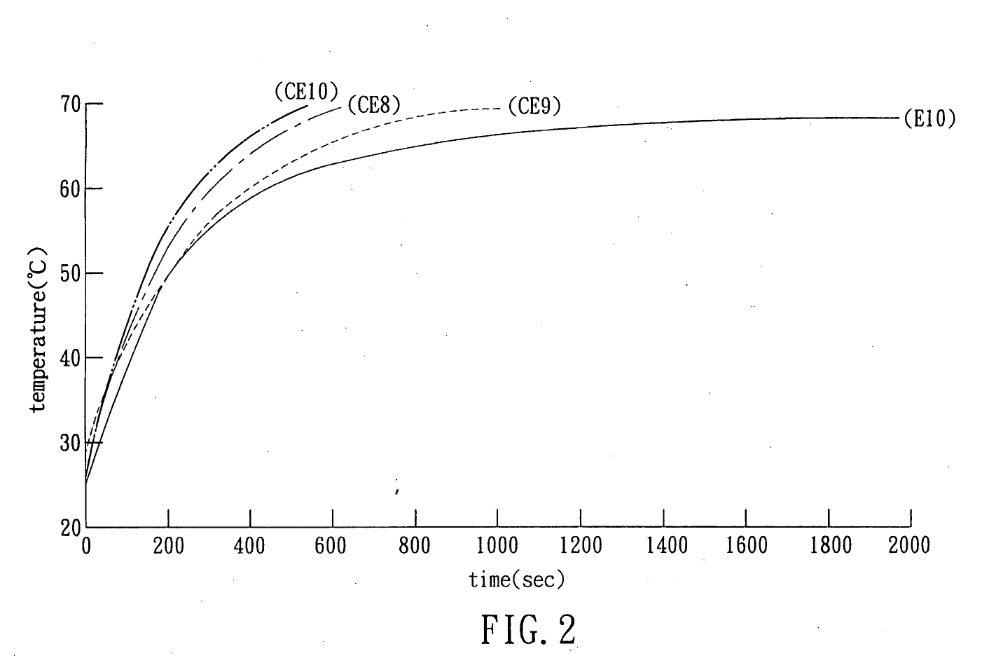

FIG. 2 is a plot showing temperature/time relation during the heat dissipation test for Example 10 and Comparative Examples 8-10. The results show that the temperature profile for Example 10 is lower than that of Comparative Examples 8-10, which indicates the thermal interface material of the invention has a better heat-dissipating efficiency.

By modifying the thermal interface material with the functional groups of OR₁ and NR₂R₃ according to the method of this invention, the a foresaid drawbacks associated with the prior art can be overcome.

With the invention thus explained, it is apparent that various modifications and variations can be made without departing from the spirit of the present invention. It is therefore intended that the invention be limited only as recited in the appended claims.

What is claimed is:

1. A thermal interface material comprising:
a viscous material of silicone polymer; and
a modified carbon nanotube material dispersed in said viscous material and having a formula:
Y—(COX)ₙ;
wherein n>1;
wherein Y is carbon nanotube, and X is selected from one of OR₁ and NR₂R₃; and
wherein R₁ is C₁-C₂₇ alkyl group, R₂ is C₁-C₁₈ alkyl group, and R₃ is C₁-C₁₈ alkyl group.

2. The thermal interface material of claim 1, wherein n ranges from 3 to 18.

3. The thermal interface material of claim 2, wherein n ranges from 6 to 12.

4. The thermal interface material of claim 1, wherein said viscous material is in an amount ranging from 5 to 100 parts by weight per 1 part by weight of said modified carbon nanotube material.

5. The thermal interface material of claim 4, wherein said viscous material is in an amount ranging from 5 to 10 parts by weight per 1 part by weight of said modified carbon nanotube material.

6. The thermal interface material of claim 1, wherein said silicone polymer is selected from the group consisting of silicone oil, modified silicone oil, and combinations thereof.

7. The thermal interface material of claim 6, wherein said silicone oil is selected from the group consisting of methyl phenyl silicone oil, methyl silicone oil, and combinations thereof.

8. The thermal interface material of claim 6, wherein said modified silicone oil is selected from the group consisting of carboxyl-modified silicone oil, methyl alcohol-modified silicone oil, isobutyl-modified silicone oil, heterofunctional group-modified silicone oil, phenol-modified silicone oil, epoxy-modified silicone oil, amine-modified silicone oil, fluorine-modified silicone oil, higher alkoxyl-modified silicone oil, higher fatty acid polyester-modified silicone oil, alkyl-modified silicone oil, methyl styrene-modified silicone oil, polyester-modified silicone oil, and combinations thereof.

9. The thermal interface material of claim 1, further comprising an inorganic filler material.

10. The thermal interface material of claim 9, wherein said inorganic filler material includes conductive nanoparticles in an amount ranging from 10 to 20 parts by weight per 1 part by weight of said modified carbon nanotube material.

11. The thermal interface material of claim 10, wherein said conductive nanoparticles are made from a material selected from the group consisting of Au, Ag, Al, Sn, Cu, Ga, Ga—In alloy, AlN, Al₂O₃, SiC, Si, BN, ZnO, SiO₂, quartz, diamond, and combinations thereof.

12. The thermal interface material of claim 1, wherein the mixture of said silicone polymer and said carbon nanotube material is formed into an emulsion.

13. A method for making a thermal interface material comprising:
(a) preparing a modified carbon nanotube material having a formula:
Y—(COX)ₙ,
wherein n>1,
wherein Y is carbon nanotube, and X is selected from one of OR₁ and NR₂R₃, and
wherein R₁ is C₁-C₂₇ alkyl group, R₂ is C₁-C₁₈ alkyl group, and R₃ is C₁-C₁₈ alkyl group;
(b) mixing the modified carbon nanotube material with a viscous material of silicone polymer; and
(c) homogenizing the mixture of step (b).

14. The method of claim 13, wherein formation of the modified carbon nanotube material is conducted by:
(a1) subjecting carbon nanotubes to carboxylation so as to form carboxylated carbon nanotubes;
(a2) subjecting the carboxylated carbon nanotubes to chlorination so as to form acyl chloride carbon nanotubes; and
(a3) subjecting the acyl chloride carbon nanotubes to nucleophilic substitution by a functional group selected from one of the OR₁ and the NR₂R₃ so as to form the modified carbon nanotube material.

15. The method of claim 13, wherein homogenization of the mixture in step (c) is conducted through at least one of mechanical stirring and ultrasonic vibration techniques.

16. The method of claim 13, further comprising emulsifying the mixture of step (b).

17. The method of claim 16, wherein emulsification of the mixture is conducted by mechanical stirring under a stirring speed ranging from 2500 rpm to 6000 rpm and a temperature ranging from 25° C. to 100° C.

18. The method of claim 14, wherein the carboxylation in step (a1) is conducted in a solution of nitric acid under a temperature ranging from 50° C. to 120° C.

19. The method of claim 14, wherein the chlorination in step (a2) is conducted in a solution of thionyl chloride.

20. The method of claim 13, wherein the homogenizing in step (c) is conducted through mechanical stirring under a speed ranging from 1200 rpm to 10000 rpm and a temperature ranging from 40° C. to 200° C.

21. The method of claim 13, further comprising heating the carbon nanotubes prior to step (a) under a temperature ranging from 150° C. to 475° C.

22. The method of claim 13, further comprising degassing the mixture by mechanical stirring under a stirring speed ranging from 1000 rpm to 3600 rpm after step (c).

23. An electronic device comprising:
a substrate;
an electronic component disposed on said substrate; and
a thermal interface material disposed between and in contact with said substrate and said electronic component and including
a viscous material of silicone polymer; and
a modified carbon nanotube material dispersed in said viscous material and having a formula:
Y—(COX)ₙ;
wherein n>1;
wherein Y is carbon nanotube, and X is selected from one of OR₁ and NR₂R₃; and
wherein R₁ is C₁-C₂₇ alkyl group, R₂ is C₁-C₁₈ alkyl group, and R₃ is C₁-C₁₈ alkyl group.
